(19) United States
(12) Patent Application Publication
(10) Pub. No.: US 2011/0139843 A1
(43) Pub. Date: Jun. 16, 2011

(54) Motorcycle seat-back adjustement device and method

(76) Inventors: Barry H. Thomas, Hopkinsville, KY (US); Chris'Ann Thomas, Hopkinsville, KY (US)

(21) Appl. No.: 12/653,323

(22) Filed: Dec. 11, 2009

(51) Int. Cl. B62J 1/28; B62J 7/04

(52) U.S. Cl. 224/413; 224/418; 224/416

(57) ABSTRACT

A device for adjusting the position of the seat-back mounted on a travel luggage pack on the back of a motorcycle is disclosed. The device consists of a slide assembly mounted between the motorcycle and the luggage pack. The slide assembly comprises two parallel slide rails movably mounted on fixed lower tracks which are mounted to the back of the motorcycle. The slide rails are attached to the combined luggage pack and seat-back to allow movement of the seat-back. The device further comprises a latching mechanism to lock the slide assembly into place in selected positions.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to an accessory for a motorcycle, and more particularly to a device that can be used to adjust the position of a luggage pack with incorporated seat-back that is mounted on the back of the motorcycle. This adjustment device provides a method to allow the passenger on the second seat of the motorcycle to adjust the seat-back position for comfort and safety.

2. Description of the Related Art

Motorcycles are well known, and are commonly ridden and operated by a single rider or driver. It is not uncommon, however, for a second person to ride on the back of the motorcycle. In many cases the passenger will simply hold on to the driver to remain secure on the motorcycle. Some motorcycles, however, have a second seat for use by the passenger. This is particularly common for touring motorcycles, which are often called touring bikes. (Note, the terms motorcycle, cycle, and bike will be used synonymously throughout.) Touring bikes often have a seat-back or back rest which allows the passenger to rest back against the seat-back and not have to hold on to the driver. Examples of such seat-backs are seen in U.S. Pat. No. 5,725,138 to Zagrodnik, and U.S. Pat. No. 6,390,220 to Galbraith et al. These motorcycles also commonly have seat extensions or second seats, as well as a foot rest on either side of the frame of the bike for passenger comfort.

Most of these seat-backs are bolted to the motorcycle and are not movable. However, there is at least one previous invention drawn to a device that allows the seat-back, such as described above, to be moved. U.S. Pat. No. 5,725,138 to Zagrodnik, discloses a luggage rack and a second seat seat-back. There is pivoting arm attached to the rear fender of the motorcycle that attaches to a post that is held in a small channel. The post is secured in the channel by bolts. The seat-back is attached to the post. When the bolts are loosened the seat-back can be slid inside the channel, and then when the desired position in selected, the seat-back is secured by tightening the bolts on the post. While the '138 patent allows the seat-back to be moved, it is only movable with the use of tools to loosen and tighten the bolts.

There are a wide variety of accessories for touring bikes. These motorcycles are frequently ridden on long trips, and so there is a need for luggage for the rider and passenger to store clothing, sleeping equipment, toiletries, and a variety of other gear. There are a variety of configurations for luggage compartments used on these motorcycles. One common configuration is the “saddle-bag” which are twin compartments that hang on either side of the back wheel, much like the saddlebags used on horses from which they get their name. Another common configuration is a luggage compartment that is mounted above the back wheel. Because it is common for passengers to accompany the rider on long rides on a touring bike, many manufacturers have combined the luggage compartment with a seat-back to provide a unitary device. American motorcycle manufacturer Harley Davidson markets a popular combination called the Tour-Pak®. The Tour-Pak® mounts above the back wheel and provides storage as well as a seat-back for the passenger. Virtually all other manufacturer of touring motorcycles have similar combination seat-back and luggage compartments. These combined seat-back luggage compartments will be referred to herein as a tour pack.

One problem with the Tour-Pak®, and other similar products made by other manufacturers, is that they are mounted on the back of the motorcycle by bolts. This means that they cannot be adjusted. Motorcycle riders and their passengers come in many shapes and sizes, yet the common tour pack provides a fixed seat-back. This means that some larger riders and passengers are pressed together, which can be both uncomfortable and unsafe, particularly on lengthy trips. There is a need, therefore, for a device that will allow the passenger to adjust the position of the seat-back of the second seat.

### SUMMARY OF THE INVENTION

This invention provides an adjustable mounting frame, referred to as the slide assembly, that mounts to the back of the motorcycle. The tour pack mounts onto the adjustable mounting frame, and can be adjusted by the passenger. Most motorcycles have mounting points on the rear fender that are used to mount a variety of accessories, including different luggage mounting accessories such as saddle bags, luggage racks and luggage compartments. When the rider wishes to attach a luggage rack or compartment over the rear wheel, a mounting plate is attached to the rear fender. Every motorcycle is different, so the actual configuration of the mounting hardware will be somewhat different, but the most common configuration is at least two mounting points on either side of the fender. The luggage mounting plate is attached to the mounting points on the fender by means of bolts or other standard hardware.

The present invention comprises a slide assembly that attaches to the luggage mount, and the tour pack is attached to the slide assembly. The slide assembly has two parallel rails that slide on a fixed track, and is locked into place by a latch. The slide assembly has a series of locking points so that the slide assembly can be moved and locked into different places, thereby allowing the tour pack to be moved on the back of the motorcycle. This allows the rider and passenger to adjust the position of the second seat seat-back.

The present invention also comprises a method for using the slide assembly to produce extra room for the passenger on a motorcycle. This method is accomplished by providing a slide assembly mounted between the rear fender or rear frame of the motorcycle and the tour pack. The method further comprises adjusting the position of the slide assembly by manipulating the latch to allow movement of the slide assembly.

### BRIEF DESCRIPTION OF THE DRAWINGS

FIG. 1 is a side elevation showing a motorcycle, with a luggage mount, the slide assembly and a tour pack.

FIG. 2 is a top perspective view of the slide assembly.

FIG. 3 is a top perspective view of the slide assembly with the slide rails extended.

FIG. 4 is a bottom detailed perspective of the latch portion of the slide assembly.

FIG. 5 is a side elevation sectional view of the inner components of the slide assembly.

### DETAILED DESCRIPTION OF THE INVENTION

Detailed embodiments of the present invention are disclosed herein. It is to be understood that the disclosed embodiments are merely exemplary of the invention, and there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

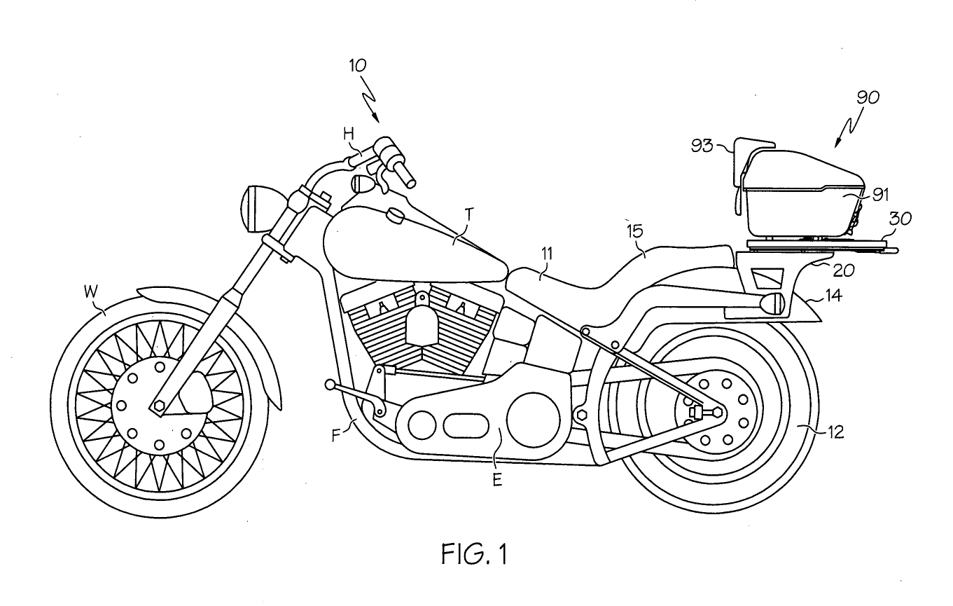

A representative motorcycle with the basic components of the present invention is shown in FIG. 1. All motorcycles have common features and they are described herein merely for reference purposes. The basic components of a motorcycle are a frame F with an engine E, a fuel tank T, and a seat 11 mounted to the frame F. There is a rear wheel 12 mounted to the back of the frame F and operably connected to the engine E. Most motorcycles transfer power from the engine E to the rear wheel 12 by means of a chain, but some motorcycles use a drive shaft. The power transfer mechanism of a motorcycle has no bearing on the present invention. At the front of the motorcycle is a front wheel W which is connected to the handlebars H. The handlebars are used to steer the motorcycle 10. Some, but not all, motorcycles also have fenders over the wheels, including a rear fender 14. Motorcycles are operated by a rider, and occasionally the rider also carries a passenger. As a result, some but not all motorcycles 10 have a second seat 15, which can either be mounted behind the main seat 11, or in some cases (as shown in the motorcycle depicted in FIG. 1) integral to the main seat 11.

If the rider desires, luggage racks or other storage devices can be mounted on the rear portion of the motorcycle. Most touring motorcycles have tubing that runs along the rear fender that is specifically designed for mounting luggage racks or luggage compartments. In many cases this tubing is directly connected to the frame F of the motorcycle 10. Other motorcycles, however, do not have this tubing, and so there is a need to mount a special mounting plate 20. In these configurations the mounting plate 20 is attached to the rear portion of the motorcycle 10. There are a wide variety of mounts and mounting plates 20, but the present invention will be defined in relation to a Harley-Davidson mount. The mounting plate 20 provides a flat place for the rider to store luggage or other gear. The specific attachment hardware and connecting procedures are well known in the art, and form no part of the present invention. While the mounting plate 20 depicted in FIG. 1 is bolted to the rear fender, the term mounting plate 20 as used herein incorporates the tubing on the back of many motorcycles, as well as any other configuration required to mount storage equipment to the back of a motorcycle 10.

Many manufacturers also make luggage compartments to store luggage and other gear. The luggage compartments are of a wide variety of sizes and configurations, and can be attached to a variety of different places on the motorcycle. The most common are storage compartments attached to the handlebar, hang over the frame like saddlebags, or attach to the rear of the motorcycle. One common luggage compartment attaches to the mounting plate 20 on the rear of the motorcycle 10. In this configurations, some manufacturers have incorporated a seat-back which allow a passenger sitting on the second seat 15 to have a back rest, which allows them to lean back comfortably and securely on the motorcycle.

FIG. 1 depicts a combination luggage compartment, referred to as a tour pack 90, having a luggage bin 91 with an attached seat-back 93. The luggage bin 91 portion of the tour pack 90 is typically constructed of a hard formed plastic. The seat-back 93 is typically constructed of a hard backing plate made of metal, a soft cushioning material placed over the backing plate, and a covering over the cushioning material and backing plate. Typically the covering is made of leather, which makes the seat-back compatible with most motorcycle seats, which are also made of leather. Leather is also used because of its durable and aesthetic properties. The seat back 93 is securely attached to the luggage bin 91. The components can be bolted together or glued together. The specific make and construction of the tour pack 90 are well known within the motorcycle accessory industry and form no part of the present invention.

The tour pack 90 is typically attached to the mounting plate 20 by means of corresponding holes and nuts and bolts that run through the holes. In the present configuration the mounting plate 20 has four mounting holes 29, two on each side. The tour pack 90 has four tour pack mounting holes 92, which are designed to correspond to and align with the mounting holes 29 of the mounting plate 20. The luggage bin 91 is a container defining an inside volume, and the holes 92 are on the bottom of the bin and so are accessible when the luggage bin is opened. Each motorcycle accessory manufacturer ensures that the holes of their mount corresponds to the holes of the associated luggage compartments. To attach the tour pack 90 to the mounting plate 20, four sets of corresponding nuts and bolts are used. In some cases there is additional mounting hardware such as washers, pads and bushings, but the specific configuration of mounting hardware is well known in the art and forms no part of this invention. The tour pack 90 is attached to the mounting plate 20 such that the seat-back 93 sits just behind the second seat 15 to provide a back rest for the passenger. One of the drawbacks of this configuration is that the seat-back 93 is fixed. The present invention is designed to provide a slide mechanism to allow the tour pack 90, and hence the seat-back 93, to be moved to accommodate different sized riders and passengers, and to provide for increased passenger comfort and safety.

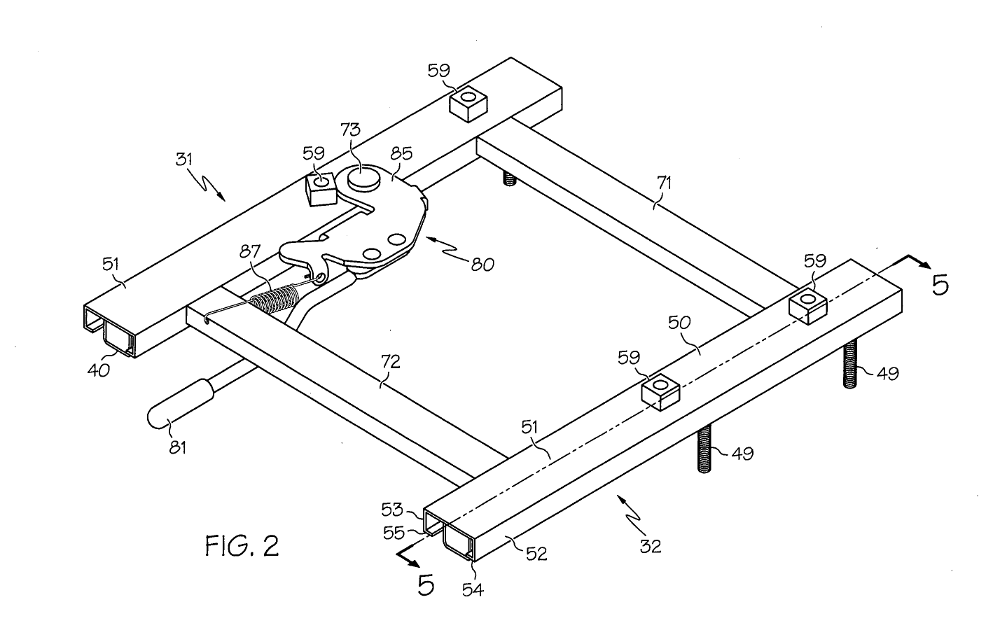

FIG. 1 shows that the slide assembly 30 of the present invention is attached between the mounting plate 20 and the tour pack 90. FIG. 2 is a perspective view of the slide assembly 30 showing most of its components. The slide assembly 30 has two parallel slide rails, a left slide rail 31 and a right slide rail 32. The slide rails 31 & 32 must be essentially parallel so that they slide together and don't bind. In the most preferred embodiment the two slide rails 31 & 32 are attached by two cross beams, a front cross beam 71 and a rear cross beam 72. The cross beams 71 & 72 ensure that the two slide rails 31 & 32 slide together. In the preferred embodiment, the slide rails 31 & 32 and the cross beams 71 & 72 are made of stainless steel. The cross beams 71 & 72 are welded to the slide rails 31 & 32 so that the slide assembly 30 is relatively flat or in a single plane. In general the slide assembly 30 is roughly one inch to one and a half inches thick. It could be somewhat thicker or thinner, though it is designed to be relatively unobtrusive when in place on the back of the motorcycle 10. It is possible that the cross beams 71 & 72 could be attached between the slide rails 31 & 32 in any conventional manner such as bolting or riveting. The cross beams 71 & 72 are attached to the upper slide 50 portion of the slide rails 31 & 32. It is also within the conception of the invention that the cross beams 71 & 72 and two upper slide portions 50 could be made from the same piece of material. It is also within the conception of the invention to have a single cross beam, and it is also possible to have no cross beams, because when the tour pack 90 is attached to the slide assembly it will lock the slide rails 31 & 32 in place and ensure that they slide together. In the preferred embodiment however, the cross beams 71 & 72 are incorporated to make the slide assembly 30 a single mechanism, which makes it easier to handle and attach.

Each slide rail 31 & 32 has the same components, with the exception of the latch mechanism which will be described below. Each slide rail 31 & 32 is made up a U-shaped fixed lower track 40 and a U-shaped movable upper slide 50 that sits over and slides on the lower track 40. The slide rails 31 & 32 are shown in more detail in FIGS. 2 & 3. In the preferred embodiment, the fixed lower track 40 is designed to be secured to the mount 20 by means of four downwardly extending bolts 49 fixedly attached to the lower track 40. The bolts 49 are positioned to correspond to the mounting holes 29 in the mounting plate 20. In the preferred embodiment, the bolts 49 are welded to the lower track, but they can be attached in any conventional manner. The bolts 49 extend through the mounting holes 29, and are secured in the conventional manner by means of washers and nuts. It is also possible, and within the conception of the invention, for the lower track 40 to have a nut attached to the underside of the assembly, and to be attached to the mounting plate 20 by means of bolts extending upward through the mounting holes 29 to securely attach to the nuts.

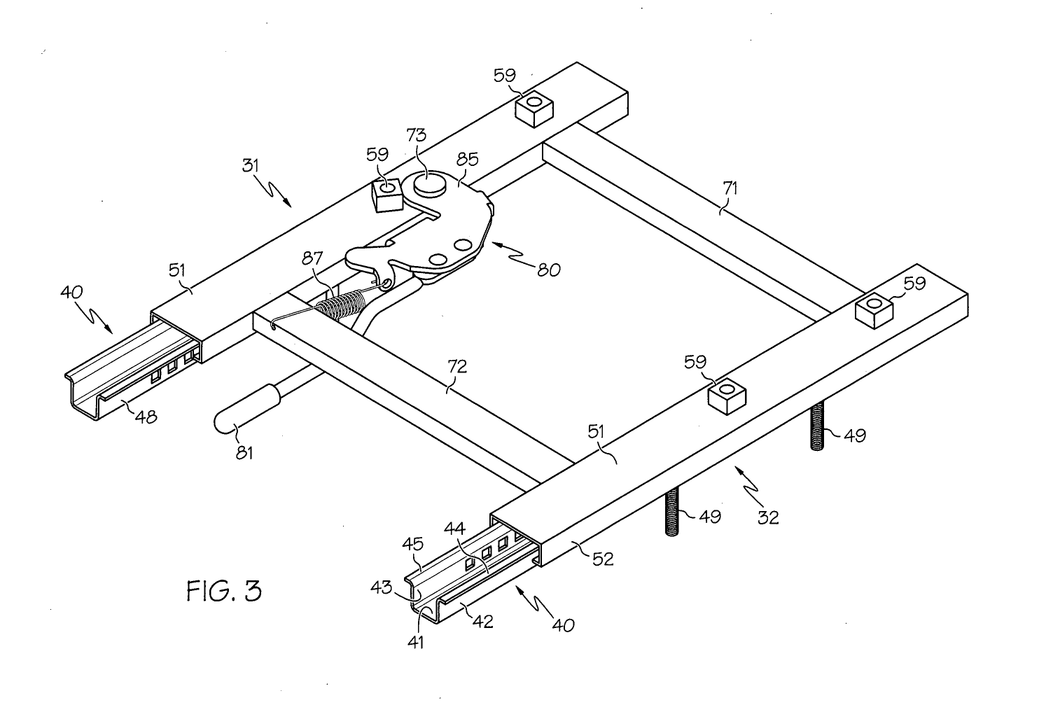

As seen in more detail in FIG. 3, the lower track 40 has a U-shaped cross section with outwardly extending upper flanges. More particularly it has a bottom plank 41, upwardly extending walls 42 & 43 attached to the plank 41, and outwardly extending flanges 44 & 45 at the upper ends of these walls 42 & 43. The junctures between these portions of the track are curved rather than sharp. The upwardly extending walls 42 & 43 have a series of evenly spaced apertures 48 that run longitudinally along the walls 42 & 43.

As shown in FIG. 2, the upper slide 50 has an inverted U-shape with inwardly directed flanges. More particularly, it has an upper plank 51 disposed above and extending to both sides of the flanges 44 & 45 of the lower track 40. A pair of downwardly extending walls 52 & 53 are provide at the opposite sides of the upper plank 51, these walls being spaced outwardly from the outer edges of the flanges 44 & 45. A pair of inwardly directed flanges 54 & 55 are formed at the lower edges of the walls 52 & 53, these inwardly directed flanges 54 & 55 are disposed essentially below the outwardly extending upper flanges 44 & 45. The junctures of the upper plank 51, the walls 52 & 53, and the flanges 54 & 55 are curved.

The movable upper slide 50 has four integrated nuts 59 fixedly attached on the on the upper portion of the slide 50. The nuts 59 can be attached in any conventional manner, though in the preferred embodiment they are welded to the upper slide. These nuts 59 are positioned to correspond to the tour pack mounting holes 92 such that the tour pack 90 can be attached to the slide assembly 30. The tour pack 90 is attached in the conventional manner to the slide assembly 30 by means of bolts and washers. It is also possible, and within the conception of the invention for there to be four integrated bolts that correspond to the tour pack mounting holes 92, and are attached by nuts and appropriate mounting hardware.

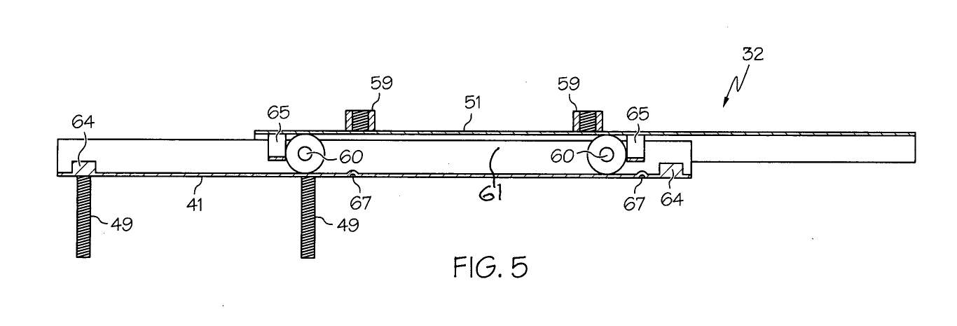

As can be seen in FIG. 5, a longitudinal space 61 is formed between the bottom plank 41 and the upper plank 51 in the space created between the upwardly extending walls 42 & 43 of the lower track 40. Rollers 60 are disposed in this longitudinal space 61. The rollers 60 are load bearing and allow the upper slide 50 to move smoothly and easily on the lower track 40. There are at least two rollers 60 disposed within the longitudinal space 61. There are two top tabs 65, one at the front and the other near the back of the longitudinal space 61. The position of these two top tabs 65 form an internal cage that prevents to the rollers 60 from rolling out of the longitudinal space 61. The top tabs 65 are small pieces of material attached to the inside portion of the upper plank 51. In the most common configuration the upper tabs 65 are small pieces of metal cut on three sides from the upper plank and bent inward into the longitudinal space. There are also two bottom tabs 64, which are also designed to prevent the rollers 60 from rolling out of the longitudinal space 61. The bottom tabs 64 can be constructed in much the same manner as the top tabs 65. It is within the conception of the invention for the top tabs 65 and bottom tabs 64 to be attached in any conventional manner. The top tabs 65 and bottom tabs 64 are sized so that they do not conflict when the upper slide 50 moves over the lower rail 40. There are also at least two bottom nipples 67 that jut into the longitudinal space 61. The bottom nipples can be created by pressing an inwardly extending node into the metal of the bottom plank 41. The position of the bottom nipples 67 will determine how far the rollers 60 can move, and this in turn will determine how far the upper slide 50 can move in relation to the lower track 40.

In one embodiment, the rollers 60 are relatively flat wheel-like cylinders. In other embodiments the rollers can be standard ball bearings. The rollers 60 can be made from a variety of different materials, from metals to plastics. The rollers 60 are load bearing, but it should be understood that they only have to bear the weight of the tour pack 90 and contents. As a result the rollers 60 need to be durable, but not unusually strong. In the most preferred embodiment the slide assembly 30 is made of stainless steel, which is used for its durability, but it is also possible that the slide assembly 30 could be constructed of another suitably strong and durable metal or other material such as hard plastic.

In some configurations of the slide assembly 30 there is a longitudinal channel space that is formed between the downwardly extending walls 52 & 53 the upwardly extending walls 42 & 43 of the lower track 40. In those configurations, a multiplicity of ball bearings can be added to the channel space, and will essentially ride on the inwardly directed flanges 54 & 55. There will also be a series of tabs to retain the ball bearing within the channel space. The purpose of the ball bearings within the channel space is to prevent the upper slide 50 from moving side to side on the lower track 40, or to prevent twisting or binding.

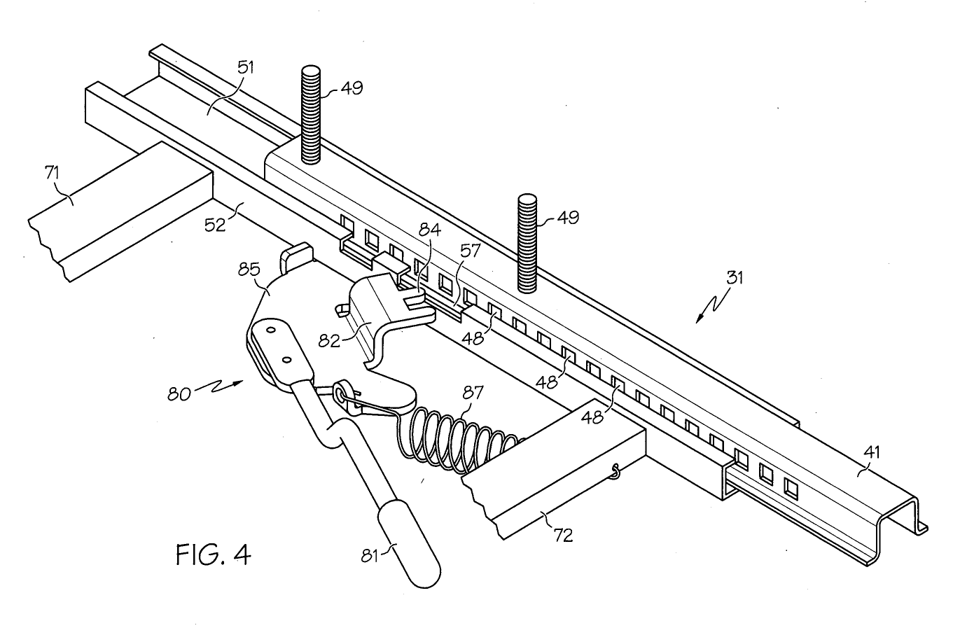

As shown in detail in FIG. 4, there is a latch 80 connected to one of the slide rails 31 or 32. The operation of the latch 80 is the same regardless of which slide rail 31 or 32 that it is attached to. In the preferred embodiment, as shown in FIG. 4, the latch 80 is attached to the left slide rail 31. As shown in FIGS. 2 & 3, the latch 80 is pivotally mounted by a pin 73 to the top of the upper slide 50. The pin 73 runs through the latch body 85 and rotatably attaches to the top of the upper slide. The latch 80 has a body 85, and a handle 81 that extends rearwardly from the body 85 and past the rear cross beam 72. In the preferred embodiment the handle 81 has a slight bend to allow it to fit under the rear cross beam 72. In the preferred embodiment the handle 81 is attached to the body 85 by a pair of rivets, but the handle 81 can be attached to the body in any conventional manner, and it is within the conception of the invention for the handle 81 to be integral with, and made from the same piece of material as, the body 85. In at least one embodiment there is a grip or handle cover made of a soft rubbery material at the end of the handle 81 away from the latch 80.

The latch 80 is forced in place by a coil spring 87 that connects from the body 85 to the rear cross beam 72. The spring 87 pulls the body 85 towards the rear of the slide assembly 30, which causes the body to rotate about the pin 73, thus pulling the body 85 against the slide rail 31. The body 85 has a downwardly extending portion 82 that sits outside the wall 54 of the slide rail 31, and a toothed portion 84 that extends inwardly into the slide rail 31 from the downwardly extending portion 82. In the preferred embodiment the body 85, the downwardly extending portion 82 and the toothed portion 84 are made of a single piece of material. In the preferred embodiment the material is stainless steel, but any suitably strong and durable material can be used. The toothed portion 84 has at least one, and in the preferred embodiment, two teeth 84. The teeth 84 pass through a slot 57 in the downwardly extending wall 52 of the upper slide 50. The teeth 84 are sized to engage the apertures 48 in the upwardly extending wall 42 of the fixed lower track 40.

When the user moves the latch handle 81 away from the left slide 31, the teeth 84 are removed from the apertures 48, which allows the upper slide 50 to move. When the user moves the latch handle 81 back toward the left slide, the teeth 84 engage the apertures 48 and lock the upper slide 50 into place. The coil spring 87 forces the latch 80 around the pin 73 and holds the teeth 84 into place in the apertures 48 such that the slide assembly 31 cannot move. This prevents the slide assembly 30 from adjusting its position. It is important that the teeth 84 be sized to snuggly fit into the apertures 48, to prevent inadvertent movement of the slide assembly 30.

In the preferred embodiment, the apertures 48 are approximately one quarter of an inch wide, and are spaced apart approximately one quarter of an inch. This means that the slide assembly 30 can be moved in one quarter inch increments. It is to be understood that these dimensions are representative only, and it is possible and within the conception of the invention for the apertures 48 to be slightly smaller or slightly larger, and to be spaced slightly further apart and slightly closer together. The main limitation of the spacing on the apertures 48 is that the material between the apertures 48 must be of sufficient width to provide structural stability. If the material between the apertures 48 is too thin there is the possibility that it could break.

In the preferred embodiment the slide assembly 30 is approximately 16 inches long. This size is designed to accommodate the Harley Davidson® style mounting plates 20 and tour packs 90. Other motorcycle manufacturers make mounts of slightly different sizes, and it is within the conception of the invention for the slide assembly to be appropriately sized to correspond the mounts 20 and tour packs 90 produces by any manufacturer. In the preferred embodiment the slide assembly is designed to move no more than four inches in one quarter inch increments. The position of the top tabs 65, bottom tabs 64, and bottom nipples 67 will determine how far the slide assembly 30 can move.

The disclosed preferred embodiment was drawn to the lower track 40 as fixed to the mount 20 and the upper slide 50 movable by means of the rollers 60 on the lower track 40, but it is within the conception of the invention for the slide assembly 30 to be inverted. The present invention was described with the latch 80 attached to the left slide 31, but it is within the conception of the invention for the latch 80 to be attached to the right side. It is also within the conception of the invention for the upper slide 50 to be secured to the lower rail 40 by the means of other types of connectors. For example a simple sling mounted pawl could be attached the upper slide 50 which could be pulled out of the apertures 48 to allow movement of the upper slide 50 over the lower track 40.

In use, the user will attach the mounting plate 20 to the rear portion of the motorcycle 10 by the method described by the manufacturer. The user will then attach the slide assembly 30 to the mounting plate 20. In the preferred embodiment the bolts 49 will be inserted into the mounting holes 29, and secured by nuts. Next the user will attach the tour pack 90 to the slide assembly 30 such that the seat-back 93 sits behind the second seat 15. The rider and passenger can then mount the motorcycle 10 and determine if the seat-back 93 is in the desired position. If the passenger wishes to change the position of the seat-back 93, he or she can adjust the position by manipulating the latch 80 and sliding the tour pack 90 into the desired position. When the latch 80 is released, the teeth 84 will engage the apertures 48 and lock the slide assembly 30 into place.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

We claim:

1. A device for adjusting a combined seat-back and luggage compartment of a motorcycle, said device comprising:
a motorcycle having a drivers seat, a passenger second seat and a rear fender;
a mounting plate attached to said rear fender;
a slide assembly attached to said mounting plate;
a combined seat-back and luggage compartment attached to said slide assembly, said seat-back proving a back rest for the second seat;
wherein said slide assembly consists of means for sliding said combined seat-back and luggage compartment, and a means for locking said combined seat-back and luggage compartment in multiple positions.

2. The device for adjusting the combined seat-back and luggage compartment of a motorcycle of claim 1 wherein said means for sliding comprises;
a pair of parallel slide rails, each of said slide rails comprising a fixed lower track and a moveable upper slide disposed over said lower track such that a longitudinal space is formed therebetween;
a multiplicity of rollers disposed within said longitudinal space such that said movable upper slide moves longitudinally over said fixed lower track;
and wherein said fixed lower track is fixedly attached to said mount, and said movable upper slide is attached to said combination seat-back and luggage compartment.

3. The device for adjusting the combined seat-back and luggage compartment of a motorcycle of claim 2 wherein said means for locking comprises;
a latch attached by a pivoting pin to said moveable upper slides of at least one of said slide rails,
wherein the corresponding fixed lower track of said at least one slide rail further comprises at least one wall, said wall having a series of apertures spaced evenly apart along said wall;
said latch having a body having a downwardly extending portion and at least one tooth extending from said downwardly extending portion, said at least one tooth positioned to engage said apertures and sized to fit within said apertures;
wherein said latch can be pivotally moved around said pin from a first position where the at least one tooth is inserted into at least one aperture to a second position where the at least one tooth is removed from said at least one to allow said upper slide to move on said rollers on said lower track, and wherein said latch can be pivotally moved to a third position where the at least one tooth is engaged in a different aperture to lock said upper slide in place over said lower fixed track.

4. The device for adjusting the combined seat-back and luggage compartment of a motorcycle of claim 3 wherein said latch further comprises;
a handle extending from said body, and
a spring having two ends, a first end attached to said body and a second end attached to said slide assembly, wherein said spring provides tension to hold said at least one tooth within said at least one aperture to lock said slide assembly in place.

5. The device for adjusting the combined seat-back and luggage compartment of a motorcycle of claim 4 further comprising at least one cross beam attached between said moveable upper slides of said parallel slide rails.

6. The device for adjusting the combined seat-back and luggage compartment of a motorcycle of claim 5 wherein said second end of said spring is attached to said at least one cross beam.

7. The device for adjusting the combined seat-back and luggage compartment of a motorcycle of claim 1 wherein said slide assembly is constructed of metal.

8. The device for adjusting the combined seat-back and luggage compartment of a motorcycle of claim 7 wherein said metal is stainless steel.

9. A device for providing extra room for a passenger and rider of a motorcycle having an attached combined luggage compartment and seat-back, wherein said motorcycle has a second seat for said passenger, a rear portion, and a mounting plate attached to said rear portion of said motorcycle, wherein said combined luggage compartment and seat-back is attached to said mounting plate, said device for providing extra room comprising;
a slide assembly mounted to said mounting plate, said slide assembly sized to accommodate the attachment of said combined luggage compartment and seat-back;
said slide assembly comprising at least one fixed longitudinal lower track attached to said mounting plate, and at least one movable upper slide movably attached to said fixed lower track such that it moves longitudinally over said lower track, wherein said combined luggage compartment and seat-back is attached to said movable upper slide;
and means for locking said upper slide in a desired position on said lower track.

10. The device for providing extra room for a passenger and rider of a motorcycle of claim 9, wherein;
said movable upper slide comprises an upper plank having two downwardly extending walls therefrom, each of said downwardly extending walls having inwardly directed flanges;
said fixed lower track having a bottom plank having two upwardly extending walls therefore, each of said upwardly extending walls having outwardly directed flanges,
wherein said movable upper slide is disposed over said fixed lower track such that said inwardly directed flanges of said upper slide sit below said outwardly directed flanges of said fixed lower track and wherein a central longitudinal space is created therebetween;
wherein at least one roller is disposed within said central longitudinal space to allow said movable upper slide to roll on said fixed lower rail.

11. The device for providing extra room for a passenger and rider of a motorcycle of claim 10, further comprising;
at least two upper tabs are attached to said upper plank, and at least two bottom tabs attached to said bottom plank such that said upper tabs and bottom tabs create an internal cage to retain said at least one roller within said longitudinal space, and wherein the position of said tabs determines the distance said movable upper slide can move over said fixed lower track, which will determine the distance the combined luggage compartment and seat-back can move on the back of said motorcycle.

12. The device for providing extra room for a passenger and rider of a motorcycle of claim 9, wherein said means for locking said upper slide in a desired position on said lower track comprises;
a latch mechanism attached to said upper slide by a pivot pin, said latch mechanism having at least one protruding tooth,
wherein at least on of said upwardly extending walls of said fixed lower track contains a number of apertures spaced evenly along said upwardly extending wall;
and wherein further said tooth is sized to engage at least one of said apertures to lock said upper track into a desired position over said lower track.

13. The device for providing extra room for a passenger and rider of a motorcycle of claim 12, wherein said fixed lower track, said latching mechanism, and said at least one protruding tooth are made from a material having sufficient strength to lock said combined luggage compartment and seat-back in position to provide a back rest for the passenger of the motorcycle.

14. The device for providing extra room for a passenger and rider of a motorcycle of claim 12, further comprising;
a spring having a first end and a second end, said first end attached to said latching mechanism and said second end attached to said moveable upper slide to provide tension to hold said at least one tooth within at least one of said apertures, but allowing said at least one tooth to be removed from said at least one of said apertures to allow longitudinal movement of said moveable upper slide over said fixed lower track.

15. A method for providing extra room for a passenger on a motorcycle, said method comprising the steps of
providing a second seat on the motorcycle for the passenger;
attaching a mounting bracket on a rear fender behind said second seat of the motorcycle;
mounting a slide assembly on said mounting bracket;
securing a combined luggage bin and seat back to said slide assembly, wherein said seat back is positioned to provide a back rest should a passenger be positioned on said second seat;
wherein said slide assembly allows the combined luggage bin and seat back to be moved to multiple positions and locked in place to create additional space for potential occupant of said second seat.

16. The method for providing extra room for a passenger on a motorcycle of claim 15 comprising the further steps of;
assembling said slide assembly through the steps of;
providing a fixed lower track mounted on said mounting bracket;
disposing a movable upper slide over said fixed lower track such that a central space is created therebetween;
inserting a multiplicity of rollers within said central space;
incorporating tabs in said moveable upper slide and said fixed lower track to constrain said multiplicity of rollers within said central space and to limit the movement of said moveable upper slide over said fixed lower track; and
attaching a locking mechanism to hold the moveable upper track in any of a multiplicity of positions on the fixed lower track.
